(19) United States
(12) Patent Application Publication
(10) Pub. No.: US 2015/0318893 A1
(43) Pub. Date: Nov. 5, 2015

(54) LOWERING TRANSMISSION POWER RESPONSIVE TO BROADCAST RADIO TRANSMISSIONS

(71) Applicant: QUALCOMM Incorporated, San Diego, CA (US)

(72) Inventors: Ehab Tahir, Mississauga (CA); Brian James Langlais, Almonte (CA); Joubin Karimi, Ottawa (CA)

(21) Appl. No.: 14/494,268

(22) Filed: Sep. 23, 2014

Related U.S. Application Data
(60) Provisional application No. 61/986,840, filed on Apr. 30, 2014.

(51) Int. Cl. H04B 3/54; H04W 24/10; H04L 12/18

(52) U.S. Cl. CPC H04B 3/54; H04L 12/189; H04W 24/10; H04B 2203/5425

(57) ABSTRACT

Transmission power of a signal may be lowered in response to detecting a broadcast radio transmission. A communication device may communicate via a powerline communication (PLC) medium by transmitting, via the PLC medium, a signal having at least a first carrier frequency. The communication device may detect a broadcast radio transmission. The communication device may lower a transmission power setting associated with the first carrier frequency from a first power level to a second power level that is lower than the first power level in response to detecting the broadcast radio transmission. The communication device may transmit, via the PLC medium, the signal having at least the first carrier frequency at the second power level during a time period associated with the broadcast radio transmission.

### CROSS-REFERENCE TO RELATED APPLICATION(S)

This application claims priority to U.S. Provisional Patent Application No. 61/986,840, entitled “Lowering Transmission Power Responsive to Broadcast Radio Transmissions,” filed on Apr. 30, 2014.

### BACKGROUND

Embodiments of this disclosure relate to the field of network communication, and, more particularly, to power characteristics of transmitted signals.

Communication technology is evolving to utilize multi-frequency transmissions over a communication medium. In many communication technologies, such as powerline communication (PLC), a transmitting device may send signals via a plurality of carrier frequencies to one or more other devices coupled to the communication medium. For example, in an orthogonal frequency division multiplexing (OFDM) technology, several carrier frequencies are used concurrently to form an OFDM symbol. Other communication technologies may also use multi-carrier transmissions in which multiple carrier frequencies are used over a communication medium.

In some cases, powerline communication transmissions have been found to interfere with broadcast radio transmissions, such as amateur radio or public radio transmissions. Governmental regulations and technical standards may be established to limit the powerline communication transmissions and reduce the interference to broadcast radio transmissions. For example, a transmitting device may limit the use of frequencies based at least in part on detecting a broadcast radio transmission.

### SUMMARY

Various embodiments are described to adjust transmission power settings of a carrier frequency responsive to detecting a broadcast radio transmission.

In one embodiment, a signal may be transmitted, via a PLC medium, having at least a first carrier frequency. A broadcast radio transmission may be detected. A transmission power setting associated with the first carrier frequency may be lowered from a first power level to a second power level that is lower than the first power level in response to detecting the broadcast radio transmission. The signal having at least the first carrier frequency at the second power level may be transmitted, via the PLC medium, during a time period associated with the broadcast radio transmission.

### BRIEF DESCRIPTION OF THE DRAWINGS

The present embodiments may be better understood, and numerous objects, features, and advantages made apparent to those skilled in the art by referencing the accompanying drawings.

FIG. 1 is a diagram illustrating an example system in which a transmission power setting may be adjusted in accordance with an embodiment of the present disclosure.

FIG. 2 is an illustration showing timing that may be used with a transmission power setting in accordance with an embodiment of the present disclosure.

FIG. 3 is an example flowchart illustrating adjustments to transmission power settings in accordance with an embodiment of the present disclosure.

FIG. 4 shows an example of transmission power settings in a multi-carrier communication system in accordance with an embodiment of the present disclosure.

FIG. 5 is an example flowchart illustrating adjustments to transmission power settings in accordance with an embodiment of the present disclosure.

FIGS. 6A and 6B are example flowcharts illustrating adjustment to transmission power settings based on channel information in accordance with embodiments of the present disclosure.

FIG. 7 shows an example message format for communicating a transmission power setting in accordance with an embodiment of the present disclosure.

FIG. 8 is an example block diagram of one embodiment of an electronic device that adjusts transmission power settings in accordance with an embodiment of the present disclosure.

### DESCRIPTION OF EMBODIMENT(S)

The description that follows includes exemplary systems, methods, devices, techniques, instruction sequences, and computer program products that embody techniques of the present disclosure. However, the described embodiments may be practiced without these specific details. For instance, although some examples may refer to adjusting transmission power settings for powerline communication, the various adjustment techniques taught by this disclosure may be applicable to other communication technologies. In other instances, well-known instruction instances, protocols, structures and techniques have not been shown in detail in order not to obfuscate the description.

An OFDM symbol may include signals at multiple carrier frequencies, and the carrier frequencies may have different power levels. In one example, a transmission power setting for a first carrier frequency may define the power level for the first carrier frequency independently from other transmission power settings for other carrier frequencies. Transmission power settings may indicate power levels associated with different carrier frequencies of a transmitted signal. The transmission power setting for a carrier frequency may include power level, modulation, and so forth. In accordance with this disclosure, the transmission power setting may be adjusted based on applicable laws, regulations, signal-to-noise ratios, channel conditions, and/or other constraints.

In one example, power levels for carrier frequencies may be based, at least in part, on applicable regulations, channel conditions, or transmitter power constraints. Some communication systems operate in environments where regulations limit the transmission power that can be used at any given carrier frequency. For example, a regulation (referred to as EN50561-1) has recently been passed to regulate powerline communication devices operating in Europe. Likewise, other regulations in other geographic areas or jurisdictions may similarly regulate powerline communication. This regulation allows increased transmission power on some carrier frequencies, but further limits the power levels for carrier frequencies that may interfere with broadcast radio transmissions (sometimes referred to as jammers). The regulation may indicate reduced thresholds for power levels associated with the carrier frequencies and time limits associated with utilizing the reduced thresholds in response to detecting broadcast radio transmissions. Performance of the powerline communication network may be negatively affected if a transmitting device completely ceases transmissions on the carrier frequencies that cause interference.

This disclosure provides several mechanisms for adjusting transmission power to mitigate interference with broadcast radio transmissions. The transmission power may be adjusted in accordance with regulations as well as channel conditions. For example, a signal utilized for communication may include a first carrier frequency. A transmission power setting associated with the first carrier frequency may be adjusted from a first power level to a lower second power level in response to detecting a broadcast radio transmission.

In one embodiment, a threshold for the second power level may be set by laws or regulations. The second power level may be utilized to communicate the signal at the second power level for a time period associated with the broadcast radio transmission. For example, the time period may include during the broadcast radio transmission, and optionally for a delay following completion of broadcast radio transmission. In some embodiments, the second power level is used for the first carrier frequency while maintaining the transmission power settings for other carrier frequencies in the signal. Transmission power settings may be adjusted individually or as a group in response to detecting an associated broadcast radio transmission.

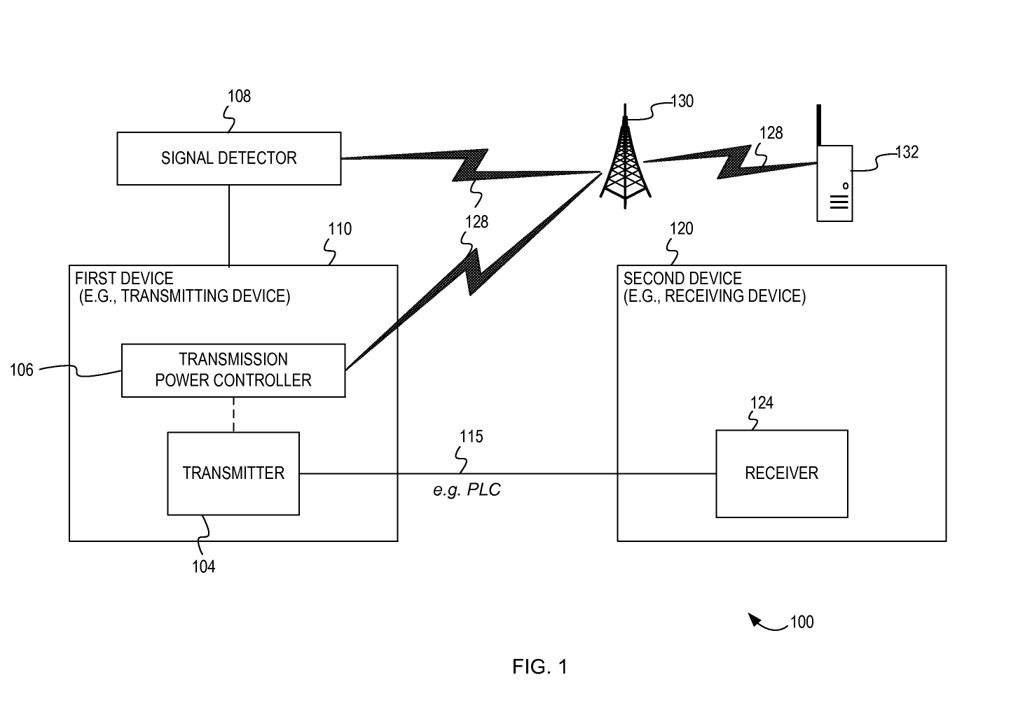

FIG. 1 illustrates a system 100 in which a first device 110 and a second device 120 are communicatively coupled to a communication medium 115. In one example, the communication medium 115 may utilize powerline communication (PLC) over a powerline medium. In other alternatives, the communication medium 115 may be a variety of communication mediums capable of carrying multi-carrier transmissions from one device to another device.

In the example in FIG. 1, the first device 110 may be referred to as a transmitting device and the second device 120 may be referred to as a receiving device. In some embodiments, both the first device 110 and second device 120 may be capable of both transmitting and receiving signals via the communication medium 115. In the example of FIG. 1, the first device 110 is referred to as a transmitting device to focus on the transmitting features. The first device 110 may include a transmitter 104. The transmitter 104 may be coupled to the communication medium 115 via a physical interface (not shown) such as an antenna, port, electrical interface, etc. In one embodiment, the transmitter 104 may be a part of a transceiver. The first device 110 may include a communication unit (not shown) which regulates communication via the communication medium 115. For example, the communication unit may also include a receiver for communication with the second device 120. The first device 110 and the second device may include a number of components that are not illustrated for purposes of simplicity, including, but not limited to, processor(s), memories, busses, digital logic, boards, amplifiers, network cards, network interfaces, power supplies, and so forth.

In the example of FIG. 1, the first device 110 may detect a broadcast radio transmission 128. The first device 110 may also determine one or more carrier frequencies transmitted by the transmitter 104 that interfere with the broadcast radio transmission 128. For example, as a full power signal is communicated from the first device 110 to the second device 120 through the communication medium 115, the signal may include a signal component that interferes with the broadcast radio transmission 128. During transmission of the signal through the communication medium 115, the communication medium 115 may act as an antenna, producing a wireless signal that may interfere with or mask the broadcast radio transmission 128. In one embodiment, a determination of interference may be made based on carrier frequencies that have been previously documented (e.g., testing, documented results in the area, user reports, etc.) as interfering with the broadcast radio transmission 128. For example, carrier frequencies that interfere with the broadcast radio transmission 128, time periods for reducing the transmission power setting, and the associated transmission power settings may be recorded in a memory (e.g., carrier frequency database) associated with the system 100. In another example, a regulatory, industry, or consumer group or body may document known interference based on theoretical information, real world applications, or laboratory testing for reference by any number of parties.

Laws or regulations may specify limits to the transmission power settings that are used by the transmitter 104 upon detection of the broadcast radio transmission 128. The transmission power settings may also be established by one or more communication standards, protocols, or industry practices. In one example, the regulations may specify a first power level for communication between the first device 110 and the second device 120 and a second power level associated with the broadcast radio transmission 128 that is to be utilized for a designated time period. For example, the second power level may be utilized during the broadcast radio transmission (following detection of the broadcast radio transmission) and for a delay following completion of the broadcast radio transmission.

In one embodiment, a signal detector 108 may detect the broadcast radio transmission 128 during communication. Once the broadcast radio transmission 128 is detected, a transmission power controller 106 may adjust the transmission power settings utilized to communicate signals through the communication medium 115. The broadcast radio transmission 128 may represent a wireless communication between a first wireless device 130 and a second wireless device 132. For example, the broadcast radio transmission may represent an amateur radio transmission between the first and second wireless devices 130, 132.

In some embodiments, the first device 110 may communicate with or be connected to the signal detector 108. In another embodiment, the signal detector 108 may be integrated with the first device 110. The signal detector 108 may send a message or indicator to the first device 110 indicating that the broadcast radio transmission 128 has been detected. The broadcast radio transmission 128 may represent a transmission that may be negatively affected by the communication between the first device 110 and the second device 120 via the communication medium 115.

In FIG. 1, the second device 120 includes a receiver 124 that couples the second device 120 to the communication medium 115. The receiver 124 may receive and process the signals received via the communication medium 115. In some embodiments, the receiver 124 may also detect the broadcast radio transmission 128. For example, the receiver 124 may anticipate a carrier frequency (to be transmitted from the transmitter 104 of the first device 110) will be communicated utilizing a decreased power level in response to detecting the broadcast radio transmission 128. As a result, the receiver 124 may be prepared to efficiently process the carrier frequency incoming at a lower power level. For example, sensitivity of the receiver 124 may be tuned or gain utilized by the receiver 124 may be increased.

The receiver 124 may also measure channel conditions, such as a signal-to-noise ratio (SNR) of the communication medium 115. The SNR measurements may be utilized to configure the receiver 124 including associated filters or other devices. SNR is used as a measurement of the quality of a transmission via a signal because the SNR correlates with the ability of the receiver 124 to interpret the transmitted signal across the communication medium 115. In one embodiment, SNR measurements may be measured during the time period when the second power level is used to transmit the signal. The SNR measurements may be provided to the first device 110 to allow the first device 110 to efficiently adjust power levels following the end of the broadcast radio transmission based on the SNR measurements. In another embodiment, the channel conditions regarding the transmission of a signal may include measurements, such as the signal-to-interference-plus-noise (SINR).

In one embodiment, the SNR measurements may also be utilized to determine the broadcast radio transmission is finished. For example, changes in the SNR measurements may indicate that the broadcast radio transmission is no longer transmitting. The SNR measurements may also be utilized to measure the influence of the broadcast radio transmission on a number of carrier frequencies as well as adjacent carrier frequencies. In one embodiment, a first set of carrier frequencies may be adjusted in response to detecting broadcast radio transmission. A number of adjacent carrier frequencies may be adjusted in response to detecting a broadcast radio transmission at a carrier frequency. For example, to achieve a low power level (sometimes referred to as a notch power level) at the carrier frequency (sometimes referred to as the notch frequency), several adjacent carrier frequencies adjacent to the notch frequency may be adjusted. The amount of adjustment to the adjacent frequencies may vary to achieve the notch power level for the notch frequency. In another embodiment, power levels of non-adjacent frequencies (for example harmonic multiples or intermodulation components) may be adjusted so that the notch power level for the notch frequency.

As described, the system 100 may be adjusted in response to detecting the broadcast radio transmission 128. The signal communicated between the transmitter 104 and the receiver 124 may utilize multiple carrier frequencies. In one example, the transmission power controller 106 may adjust the transmission power settings utilized by the transmitter 104 for a carrier frequency or frequencies that may interfere with the broadcast radio transmission 128. For example, the transmission power settings include power levels for a second carrier frequency that may not interfere with the broadcast radio transmission 128, such that the second carrier frequency remains unchanged.

In another example, the transmission power controller 106 may adjust the transmission power settings for the carrier frequency associated with the broadcast radio transmission 128 as well as adjacent frequencies. For example, the transmission power controller 106 may adjust the transmission power settings for the first carrier frequency and a set of carrier frequencies that are adjacent the first carrier frequency. Distinct power settings may be associated with the different carrier frequencies.

In another example, the transmission power controller 106 may adjust the transmission power settings for a second carrier frequency in response to detecting the broadcast radio transmission. For example, the broadcast radio transmission may be an indication that other broadcast radio transmissions are possible. Therefore, in response to detecting the broadcast radio transmission, the transmission power controller 106 may adjust the transmission power settings for both a first carrier frequency and a second carrier frequency. The second carrier frequency may or may not be adjacent to the first carrier frequency. In one embodiment, detection of a broadcast radio transmission may cause the transmission power controller 106 to adjust transmission power for a set of carrier frequencies. For example, a set of carrier frequencies may be associated with a potential frequency of broadcast radio transmission 128. The transmission power controller 106 may adjust transmission power for the set of carrier frequencies in response to detecting the potential frequency of broadcast radio transmission 128. In one embodiment, the transmission power controller 106 may also adjust transmission power for multiple sets of carrier frequencies.

As previously noted, the transmission power settings utilized by the transmission power controller 106 may also be controlled based, at least in part, on the channel conditions associated with the communication medium 115, such as SNR, attenuation, errors, and so forth. In one example, channel conditions (e.g., SNR values) may be detected by the receiver 124 and utilized to select a transmission power setting, such as the power level and modulation implemented for the carrier frequency. For example, the second device 120 may communicate the channel conditions to the first device 110.

The transmission power settings utilized by the transmission power controller 106 may include multiple power levels that are implemented by the transmitter 104 to communicate the signals through the communication medium 115. In one embodiment, transmission power settings may be associated with a distinct carrier frequency or frequency range. For example, a high power level or default power level may be utilized for communication through the communication medium 115 when the broadcast radio transmission 128 has not been detected for a time period. The time period may include a delay following a broadcast radio transmission 128. The time period may be established by regulation, a standards group, a communication service provider associated with the system 100, or other parties operating the first device 110 and the second device 120. For example, the time period may be three minutes.

The transmission power controller 106 may select a lower power level that is utilized in response to detecting the broadcast radio transmission 128. For example, the transmission power controller 106 may send an indicator, command, or message for the transmitter 104 to implement the lower power level in response to detecting the broadcast radio transmission 128. The transmission power controller 106 may ensure that the lower power level (e.g., second power level) is utilized for the time period.

In one embodiment, the transmission power controller 106 may include a timer for determining a delay after completion of the broadcast radio transmission 128. For example, if the first and second wireless devices 130, 132 communicate broadcast radio transmissions back and forth steadily over a period of five minutes, the transmission power controller 106 may configure the transmitter 104 to utilize the lower power setting during the five minutes of ongoing communication and for three minutes of delay after completion of a detected broadcast radio transmission. As a result, the transmitter 104 may communicate the signal utilizing the lower power threshold for eight minutes total in this example.

The second device 120 may receive signals from the first device 110 and determine channel conditions of the carrier frequencies associated with the communication medium 115. Channel conditions may be measured or estimated at regular intervals for one or more carrier frequencies. The channel conditions regarding the transmission of a signal may include measurements, such as the SNR. Often, “noise” will be defined to include interference as well as background noise or intermittent noise. Therefore, when measuring signal to noise ratio, the measurement may be referred to as SNR or SINR interchangeably in some systems. The formula for SINR may be defined as P/(I+N) where P represents the received power, I represents the interference power of other simultaneous transmissions, and N represents the noise (such as background or intermittent noise). Another measurement that may define channel conditions is channel attenuation. In some embodiments, the transmission power settings may be adjusted in view of the channel attenuation.

The second device 120 may analyze the channel conditions and prepare a tone map (or multiple tone maps) and amplitude map to subsequently send to the first device 110. The first device 110 may utilize the tone map and amplitude map to generate subsequent transmissions to the second device 120. The physical layer transmission properties (e.g., included in a tone map) indicate which carrier frequencies are used to transmit data, as well as the type of modulation and error correction coding to be used for particular carrier frequencies. As such, a tone map may be based, at least in part, on channel conditions and throughput capability for particular carrier frequencies. For example, the channel conditions estimation process may be used to determine the maximum transmission rate possible for one or more carrier frequencies associated with the communication medium 115. Alternatively, in some embodiments, a same modulation and error correction coding may be used for all or groups of carrier frequencies. The tone map, or channel quality feedback regarding the channel conditions, may be good indicators to the first device 110 of the performance of the carrier frequencies.

The first device 110 may utilize the tone map (or other physical layer transmission properties) to set the transmission power setting, modulation, and coding scheme (MCS) associated with carrier frequencies in a multi-carrier transmission. In addition to the MCS, the first device 110 may also manage the transmission power setting associated with the carrier frequencies in accordance with the amplitude map. The amplitude map defines the relative amount of power used for one or more carrier frequencies (or groups of carrier frequencies). For example, in one implementation, the amplitude map may include a single value for each carrier frequency to indicate a relative power level for the carrier frequency (e.g., “−30” for carrier frequencies that have a reduced power level −30 dB from a maximum power level or baseline power level). The transmission power settings of a transmission signal may be used to describe the power levels for particular carrier frequencies. Empirically, the transmission power setting of a particular signal may be measured, such as with a spectrum analyzer, or may be determined (e.g., calculated), for example, based, at least in part, on information about the tone map, amplitude map (power level), or other channel conditions of the transmitted signal.

In one embodiment, the transmission power controller 106 may track the carrier frequencies associated with the broadcast radio transmission 128 to determine the transmission power settings utilized for one or more of the carrier frequencies. For example, the broadcast radio transmission 128 may not be affected by all of the carrier frequencies implemented in the communication medium 115. Thus, the transmission power controller 106 may utilize the frequency range of the broadcast radio transmission 128, tone map, amplitude map, and channel conditions to define the transmission power settings for the distinct carrier frequencies.

The first device 110 may maintain predefined or selectable transmission power settings, profiles, or modes that are utilized for the different carrier frequencies. The transmission power settings may establish power level, modulation, time period for maintaining power levels, detection settings, and other relevant information. The transmission power settings may also establish whether the transmission power settings of adjacent carrier frequencies are also adjusted based on detection of the broadcast radio transmission 128. The transmission power settings and other applicable information for the devices of FIG. 1 may be updated periodically or in real-time based on changing regulations or standards through authorized messages, packets, scripts, programs, automatic updates, manual updates, or so forth.

In one embodiment, information about the transmission power setting may be communicated from the first device 110 to the second device 120. For example, the transmission power controller 106 may cause a message or part of a message to be sent to the second device 120 to inform the second device 120 regarding transmission power settings of the first device 110. For example, the transmission power controller 106 may inform the second device 120 regarding power settings utilized for transmission power levels, modulation schemas, or other transmission related information. The second device 120 may utilize the transmission power setting information to receive transmissions from the first device 110. The information about the transmission power settings may be communicated in a same message or in separate messages. In another example, the information about the transmission power settings may be included in a first part of a transmission (such as a preamble or header) to indicate the transmission power settings that are being used in response to detecting the broadcast radio transmission 128.

As shown in FIG. 1, the first device 110 may also include the transmission power controller 106 to implement various features of the embodiments. For example, the transmission power controller 106 may modify transmission power settings (e.g., increase or decrease), of the transmitter 104. The transmission power controller 106 may send commands to the transmitter 104 causing the transmitter to utilize the specified transmission power settings. In one embodiment, the transmission power controller 106 may include logic (e.g., application specific integrated circuit, chipset, field programmable gate array, etc.) to perform various features and operations. In another embodiment, the transmission power controller 106 may include a processor and a memory storing instructions that upon execution cause the transmission power controller 106 to implement the various described features and operations.

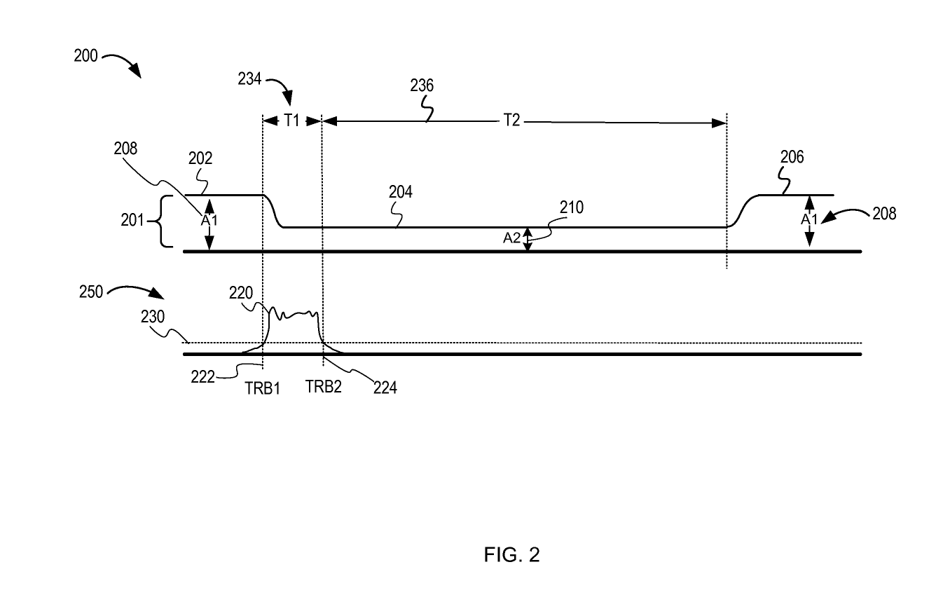

FIG. 2 illustrates some concepts regarding timing that may be used with transmission power settings. A first timing diagram 200 of FIG. 2 illustrates a signal 201 having at least a first carrier frequency. For simplicity, in FIG. 2, the power level(s) for a first carrier frequency are depicted, but other carrier frequencies (not shown) may also be present. In the first timing diagram 200, time increases from left to right. To aid in describing the timing, the signal 201 is described as having first, second, and third segments 202, 204, 206 occurring sequentially over time.

A second timing diagram 250 corresponding to the first timing diagram 200 illustrates a broadcast radio transmission 220 that begins at first time (TRB1) 222 and ends at second time (TRB2) 224. The broadcast radio transmission 220 is a representation of all or portions of a broadcast radio transmission. The broadcast radio transmission 220 may represent a single transmission or may be one of multiple transmissions by one or more radio devices, systems, or equipment.

In one embodiment, the broadcast radio transmission 220 may be detected once the amplitude exceeds a threshold 230. In addition, the broadcast radio transmission 220 may be determined to be completed once the broadcast radio transmission 220 drops below the threshold 230. The threshold 230 may also be set by laws or regulations. In another embodiment, the threshold 230 may correspond to the sensitivity or technical abilities (or limitations) of one or more detectors or receivers that detect the broadcast radio transmission 220.

As shown, the first segment 202 and the third segment 206 may be transmitted at a first power level (A1) 208. The first power level 208 may represent a default power level for communication via the carrier frequency used before (and after) detecting the broadcast radio transmission 220. For example, the first power level 208 may be a maximum power level for the carrier frequency. The second segment 204 begins in response to detecting the broadcast radio transmission 220. During the second segment 204, the carrier is transmitted at a second power level (A2) 210. The second power level 210 may be a reduced power level as compared to the first power level 208. In one example, the first power level 208 and second power level 210 are distinct configurations of the transmission power setting for the signal 201 and the corresponding transmitting device. For example, the second power level 210 may represent a power level threshold set by an applicable regulation and applied in environments where the broadcast radio transmission 220 is detected to limit potential interference.

The broadcast radio transmission 220 may last for a first time period (T1) 234. The broadcast radio transmission 220 may end at the second time 224. The broadcast radio transmission 220 may be of any length or duration. Once the broadcast radio transmission 220 ends, a second time period (T2) 236 (which may also be referred to as a delay) may follow completion of the broadcast radio transmission 220. In one embodiment, a duration of the second time period 236 may be set by a regulation. A timer of a transmitting device may track the second time period 236. For example, in response to determining that the second time period 236 of three minutes has passed, the transmitting device may transition from the second power level 210 of the second segment 204 to the first power level 208 (or a different power level, not shown) of the third segment 206.

In one embodiment, the first power level 208 of the third segment 206 may be the same as the first power level 208 of the first segment 202. In another embodiment, the power level of the third segment 206 may vary based on channel conditions (e.g., SNR measurements) or other factors. For example, the first power level 208 and the second power level 210 may be associated with thresholds that establish a maximum power level based on whether the broadcast radio transmission 220 has been detected. In one embodiment, the power level used during the third segment 206 may be based at least in part on SNR measurements of the signal 201 that were measured by the receiving device during the second segment 204. The receiving device may provide the SNR measurements (or related data) to the transmitting device. The transmitting device may then increase the power level of the signal 201 during the third segment 206 based on the SNR measurements (or related data). The transition from the second power level 210 back to the first power level 208 may occur in a single step, in multiple incremental steps, or gradually utilizing a ramp-up period.

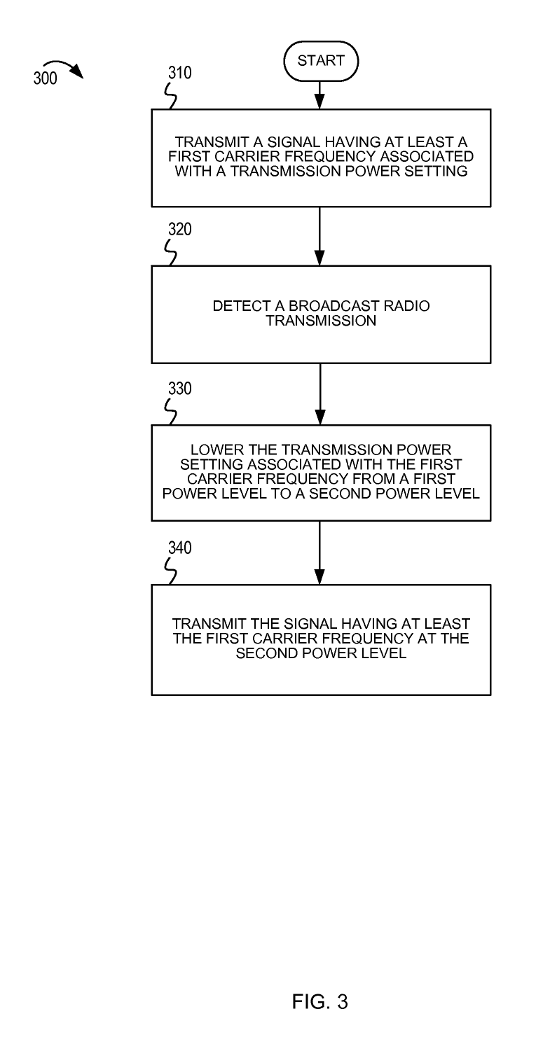

FIG. 3 is an example flowchart 300 illustrating adjustments to transmission power settings in accordance with an embodiment of the present disclosure. Operations of the flowchart 300 may be performed by any number of computing or communication devices. In one embodiment, a transmitting device may implement the operations described by the flowchart 300. In some embodiments, a system including at least a transmitting device, a receiving device, and/or any number of other devices may implement subsets of the operations.

At 310, a communication device may transmit a signal having at least a first carrier frequency associated with a transmission power setting. In some embodiments, the signal may represent powerline communication sent via a powerline communication medium. The signal may include multiple carrier frequencies in addition to the first carrier frequency.

At 320, the communication device may detect a broadcast radio transmission. The communication device may include a receiver that detects the broadcast radio transmissions within one or more specified frequency ranges. In some embodiments, the communication device may receive a message or an indicator of the broadcast radio transmission being detected by a remote device, such as a receiver or other detecting device. The communication device may also determine carrier frequencies that may be affected by the broadcast radio transmission. For example, the broadcast radio transmission may affect a single carrier frequency or a carrier frequency and a number of adjacent carrier frequencies. The broadcast radio transmission may represent a single transmission or a series of transmissions.

At 330, the communication device may lower the transmission power setting associated with the first carrier frequency from the first power level to a second power level. The second power level may be lower than the first power level (e.g., amplitude of the transmitted signal). The communication device may automatically lower the power level responsive to detecting the broadcast radio transmission in order to prevent unwanted interference with the broadcast radio transmission. Other adjustments may also be made to the transmission power settings.

At 340, the communication device may transmit the signal having at least the first carrier frequency at the second power level. In one example, the transmission may represent a powerline communication sent through a powerline communication medium. The transmission may also have other characteristics applicable based on the transmission power setting selected for the first carrier frequency. The second power level may be utilized after the last detected broadcast radio transmission and may be reset in response to new broadcast radio transmission being detected.

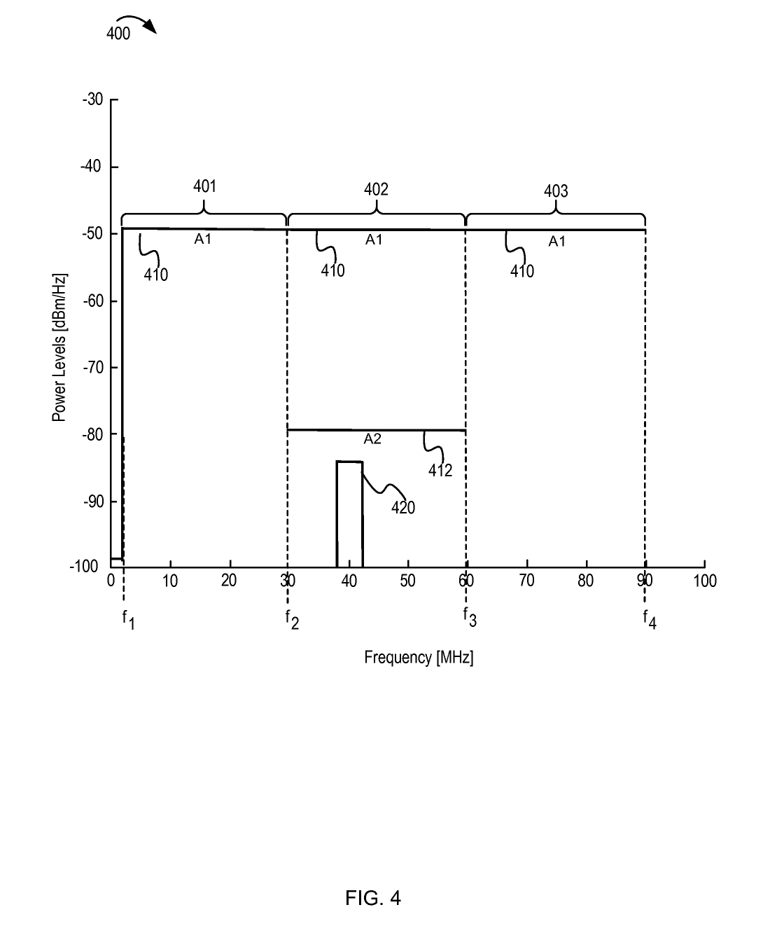

FIG. 4 shows an example of transmission power settings 400 in a multi-carrier communication system. In one embodiment, the carrier frequencies utilized (e.g., transmitted and received) by an example communication system may include a first carrier frequency range 401 from f1-f2, a second carrier frequency range 402 from f2-f3, and a third carrier frequency range 403 from f3-f4. The transmission power settings may be configured for the carrier frequency ranges 401, 402, 403 or may be selected for specific carrier frequencies within the carrier frequency ranges 401, 402, 403.

The maximum power levels utilized for communication via the first, second and third carrier frequency ranges 401, 402, 403 may be set by applicable laws, regulations, an operator/communication service provider, or communication standards or protocols. In one embodiment, the carrier frequency ranges 401 and 403 may be transmitted at a first power level (A1) 410 associated with a first transmission power setting. In one embodiment, the carrier frequency range 402 may also be transmitted at the first power level 410 during times that a broadcast radio transmission is not detected.

The carrier frequency range 402 may be transmitted at a second power level (A2) 412 in response to detecting a broadcast radio transmission 420. For example, the broadcast radio transmission 420 may occur at a frequency associated with the second carrier frequency range 402. The broadcast radio transmission 420 may be susceptible to interference from the second carrier frequency range 402 being transmitted across a powerline communication medium at the first power level 410. However, the broadcast radio transmission 420 may be unaffected (or affected within acceptable tolerances) by the second carrier frequency range 402 when transmitted at the second power level 412. As a result, the second power level 412 may be utilized by the second carrier frequency range 402 to avoid interference with the broadcast radio transmission 420.

In one embodiment, the first power level 410 may represent a default power level for the powerline communication transmitted at the first, second, and third carrier frequency ranges 401, 402, 403. The first power level 410 may also represent a maximum power level or full power threshold. In some embodiments, the first, second, and third carrier frequency ranges 401, 402, 403 may have a lower power level threshold, such as the second power level 412 shown for the second carrier frequency range 402. The lower power level threshold may be the same or different for each of the first, second, and third carrier frequency ranges 401, 402, 403.

For some communication systems, regulatory authorities, such as the Federal Communications Commission (FCC) in the United States, stipulate emission limits (radiated, conducted or other) that in turn impose limits on power transmitted from a device. For example, a manufacturer of communication equipment may derive a maximum allowable transmission power setting constraint or threshold from the regulatory limitations. The first power level 410 is an example of a threshold for a maximum allowable limit based, at least in part, on regulatory requirements. The power setting thresholds (e.g., A1, A2) may represent a maximum allowable power level threshold for powerline communication systems, to meet the regulations for a certain frequency band (0-90 MHz, in this example) in North America. In this example, the transmission power level threshold represented by the first power level 410 may be −50 dBm/Hz for the first, second, and third carrier frequency ranges 401, 402, 403. In addition, the second carrier frequency range 402 may have a reduced transmission power level threshold, such as −80 dBm/Hz when the broadcast radio transmission 420 is detected. Even though the example in FIG. 4 shows a frequency band 0-90 MHz, communication systems such as powerline communication systems may operate in other frequency bands including bands above 90 MHz.

In some implementations, transmitting at the maximum allowable power threshold (e.g., first power level 410, second power level 412) for a given frequency results in the best throughput for that frequency. However, some communication systems may reduce the transmission power setting to a level less than the maximum allowable threshold for that frequency. As a result, power levels below the first power level 410 and the second power level 412 may be utilized to prevent quantization errors based on less quantization noise and gains in fidelity based on differentials in power levels.

In some implementations, the transmission power settings may be based, at least in part, on coexistence of two or more communication technologies using same or similar frequencies. Limiting transmission power for particular frequencies may enable two or more networks to utilize the same frequency allocations, such that interference from the two or more networks does not prevent communication of one another. In North America, there are currently approximately 10 particular frequency ranges (i.e., reserved frequency ranges) that share the 1-30 MHz band otherwise associated with powerline communication. In one embodiment, a powerline communication device may reduce the transmission power settings for the first carrier frequency range 401 to a specified lower power level (not shown).

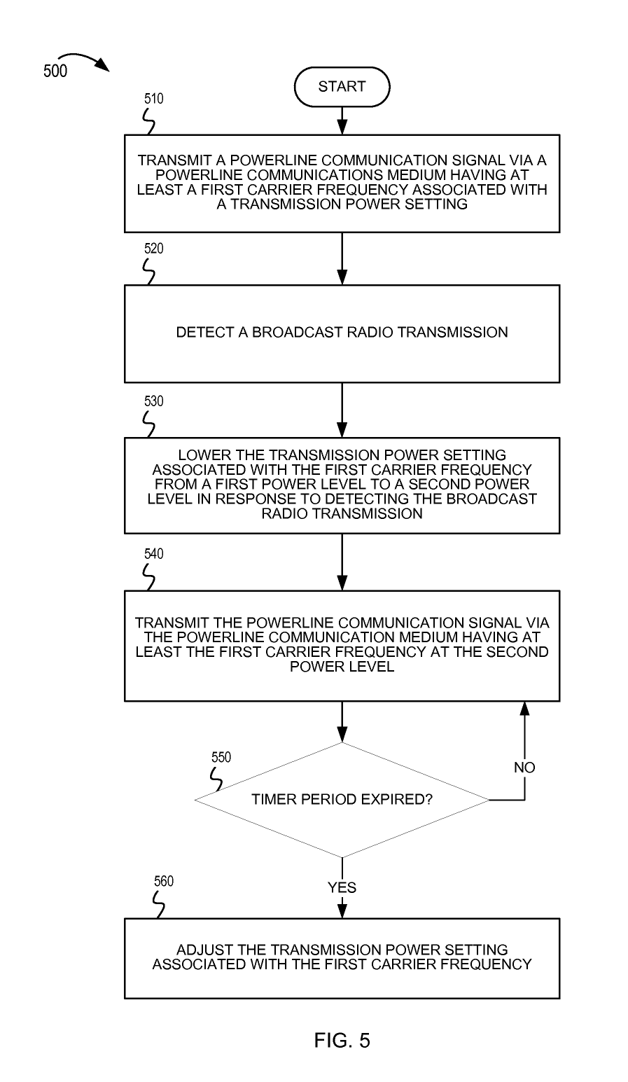

FIG. 5 is an example flowchart 500 illustrating adjustment to transmission power settings based on channel information in accordance with an embodiment of the present disclosure. At 510, a communication device transmits a powerline communication signal through a powerline communication medium having at least a first carrier frequency associated with a transmission power setting. The transmission power setting may include a first power level setting. In one embodiment, the first power level setting may also be established by regulation, communication standards or protocols, or industry practices.

At 520, the communication device may detect a broadcast radio transmission. At 530, the communication device may lower the transmission power setting associated with the first carrier frequency from a first power level to a second power level in response to detecting the broadcast radio transmission. At 540, the communication device transmits the powerline communication signal via the powerline communication medium having at least the first carrier frequency at the second power level threshold.

In one embodiment, at 550, the communication device may determine whether a time period has expired. The time period may include a delay after the last detected radio broadcast transmission. For example, a regulation may specify that the lower or second power level be utilized for three minutes after a detected radio broadcast signal is completed before the communication device may return to transmitting at a first power level (e.g., default or full power communication). The delay may also be referred to as a holddown period that governs the transmission power settings. The time period for using the second power level may be reset in response to additional broadcast radio transmissions being detected during the process of FIG. 5. In response to determining the time period has not expired, the flowchart may return to block 540.

In response to determining the time period has expired during block 550, at block 560, the communication device may adjust the transmission power setting associated with the first carrier frequency. For example, the communication device may adjust the transmission power setting associated with the first carrier frequency from the second power level to the first power level. Alternatively, the communication device may adjust the transmission power setting associated with the first carrier frequency from the second power level to the different power level based on channel conditions. In one embodiment, the channel conditions may include SNR measurements made between a transmitting device and a receiving device. The channel conditions may also include a tone map and an amplitude map that are generated. For example, the channel conditions may be sent in a message from the receiving device to the transmitting device.

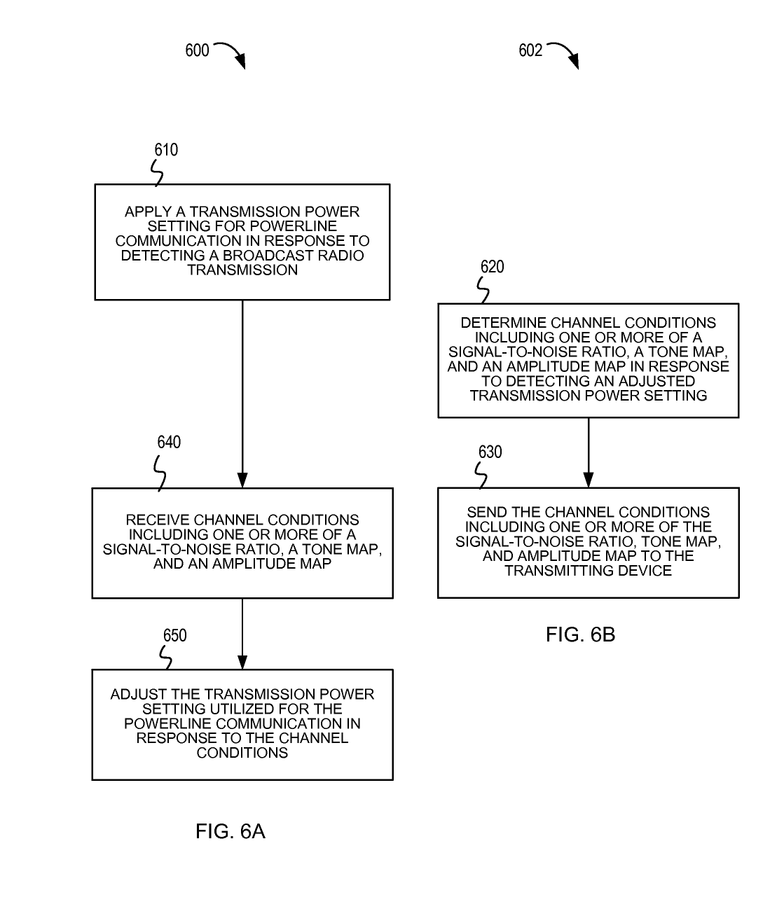

FIGS. 6A-6B are example flowcharts 600, 602 illustrating adjustment to transmission power settings based on channel information in accordance with embodiments of the present disclosure. In one embodiment, the operations of flowchart 600 may be performed by a transmitting device and the operations of flowchart 602 may be performed by a receiving device. The transmitting device and the receiving device may be in communication with one another directly or indirectly (e.g., through one or more communication mediums, nodes, connectors, networks, or so forth). For example, the transmitting device may communicate with the receiving device through a powerline communication medium and may represent a system.

At 610 of flowchart 600, the transmitting device applies a transmission power setting for powerline communication in response to detecting a broadcast radio transmission. The transmission power setting may include a reduced power level that is utilized by the transmitting device for communication via a communication medium. The transmitting device may start a timer in response to detecting a completed broadcast radio transmission. The timer may be restarted when another broadcast radio transmission is detected. In one embodiment, the transmitting device may send a message to the receiving device indicating the transmission power setting is being initiated by the transmitting device.

At 640, the transmitting device receives channel conditions including one or more of a signal-to-noise ratio, a tone map, and an amplitude map. The transmitting device may then analyze the received information, data, and measurements to determine the transmission power settings that are most effective in communication with the receiving device based on the current conditions. The transmitting device may also measure the channel conditions or receive messages from other network devices regarding the channel conditions.

At 650, the transmitting device adjusts the transmission power settings utilized for powerline communication in response to the channel conditions. The transmitting device may adjust transmission power settings, such as power level and modulation, to maximize the SNR and decrease errors between the transmitting device and the receiving device. In one embodiment, the transmitting device may adjust the transmission power settings by increasing the power level from the lower level back to a higher power level in response to the time period tracked by the timer expiring. The channel conditions, tone map, and amplitude map may be utilized to efficiently transition back to the higher power level because the channel has already been measured and analyzed.

At 620 of flowchart 602, the receiving device determines channel conditions including one or more of a signal-to-noise ratio, a tone map, and an amplitude map in response to detecting an adjusted transmission power setting. In one embodiment, the channel conditions are determined for transmission to the transmitting device. For example, the channel conditions may be provided to the transmitting device information to more quickly and accurately change or increase the transmission power settings (e.g., increasing a power level and/or changing modulation in response to determining the time period—including any delay—has elapsed).

At 630, the receiving device sends the channel conditions including one or more of the signal-to-noise ratio, tone map, and amplitude map to the transmitting device. In one embodiment, the channel conditions may be sent periodically. In another embodiment, the channel conditions may be sent in response to a request from the transmitting device, an event occurring, a threshold being met, or automatically response to a time period expiring. The information communicated at 630, may be particularly useful for adjusting the power level settings from a lower power level back to a higher power level. For example, knowing the channel conditions may allow an amplitude level and modulation to be more quickly determined and implemented between devices or in a network.

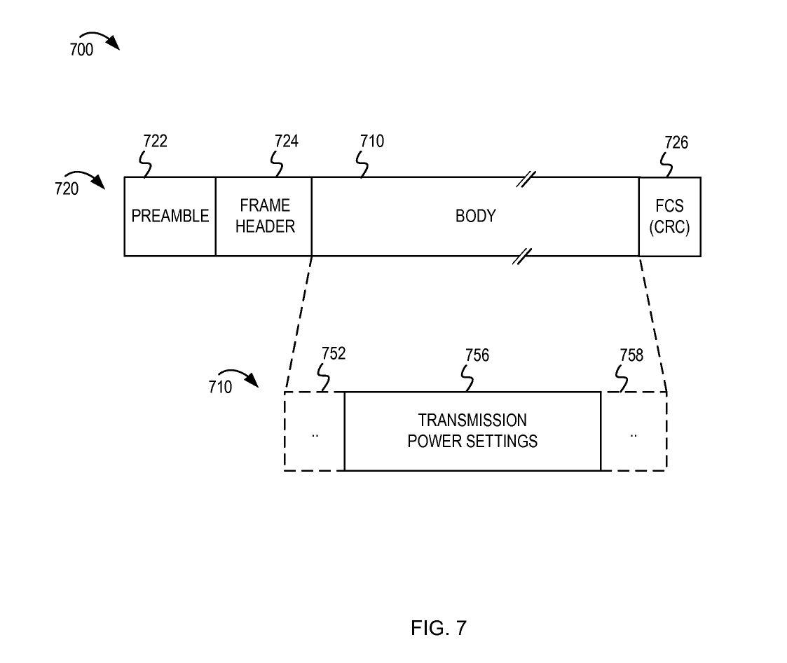

FIG. 7 depicts an example message format 700 for communicating a transmission power setting. In some embodiments, once a transmitter determines a particular transmission power setting, the transmitter may communicate the transmission power setting to the receiver. For example, the transmitter may encode the power level (or amplitude) used for one or more carrier frequencies, or for groups of carrier frequencies, and send the encoded message to the receiver. The transmitter may also communicate an estimated time for changing the transmission power setting, if known (e.g., increasing from a second power level back to a first power level after a designated time period). A message that conveys a transmitter-generated power setting may be referred to as a power message.

The example message format 700 includes a transmission frame 720 having a preamble 722, a frame header 724, a frame body 710 and a frame check sequence (FCS) 726 (e.g., for sending a cyclic redundancy check, CRC, value). The frame body 710 may be encoded with one or more fields or information elements 752, 756, 758. For example, one or more information elements 756 may include the transmission power settings encoded in a syntax understood by both the transmitter and the receiver.

In one embodiment, a transmission power settings, profile, or mode, may be transmitted as an indicator in a frame header of a transmission frame. The frame header may not use the transmission settings, while the body of the transmission frame may use the transmission settings. In another embodiment, the transmission power settings may be included as an indicator in a packet body of a transmission frame. The transmission power settings may be used for a subsequent transmission frame. In another embodiment, the transmission power settings may be communicated in the frame header 724.

In another embodiment, a receiving device or receiver may implement the message format 700 to send messages to the transmitter. For example, the information elements 756 may include channel conditions detected, measured (e.g., SNR, errors, etc.), or estimated by the receiver. The message format 700 may also be utilized by any number of other network devices to communicate channel conditions and other information.

FIGS. 1-7 and the operations described herein are examples meant to aid in understanding embodiments and should not be used to limit embodiments or limit scope of the claims. Embodiments may perform additional operations, fewer operations, operations in parallel or in a different order, and some operations differently.

As will be appreciated by one skilled in the art, aspects of the present disclosure may be embodied as a system, method, or computer program product. Accordingly, aspects of the present disclosure may take the form of an entirely hardware embodiment, a software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more non-transitory computer readable medium(s) may be utilized. Non-transitory computer-readable media comprise all computer-readable media, not including a transitory, propagating signal. The non-transitory computer readable medium may be a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code embodied on a computer readable medium for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described with reference to flowchart illustrations and/or block diagrams of methods, apparatus (systems) and computer program products according to embodiments of the present disclosure. In addition, each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

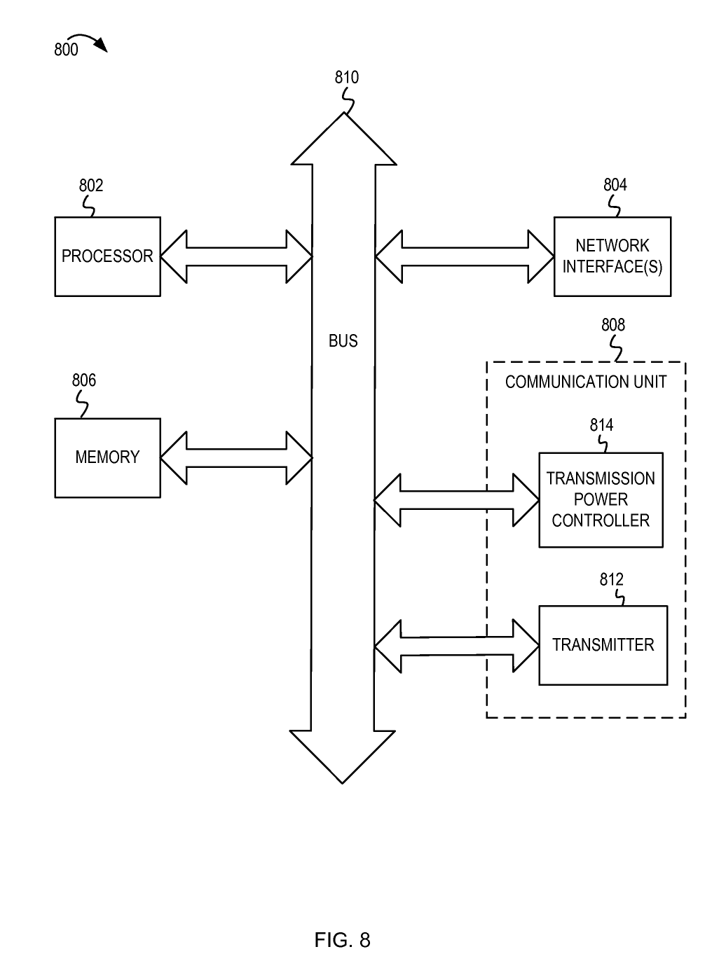

FIG. 8 is an example block diagram of one embodiment of an electronic device 800 that adjusts transmission power settings in accordance with various embodiments of this disclosure. In some embodiments, the electronic device 800 may be one of a laptop computer, a netbook, a mobile phone, a powerline communication device, a personal digital assistant (PDA), or other electronic systems. The electronic device 800 includes a processor 802 (possibly including multiple processors, multiple cores, multiple nodes, and/or implementing multi-threading, etc.). The electronic device 800 includes a memory 806. The memory 806 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The electronic device 800 also includes a bus 810 (e.g., PCI, ISA, PCI-Express, HyperTransport®, InfiniBand®, NuBus, AHB, AXI, etc.), and network interfaces 804 that include at least one member of a group consisting of a wireless network interface (e.g., a WLAN interface, a Bluetooth® interface, a WiMAX interface, a ZigBee® interface, a Wireless USB interface, etc.) and a wired network interface (e.g., an Ethernet interface, a powerline communication interface, etc.). In some embodiments, the electronic device 800 may support multiple network interfaces—each of which couples the electronic device 800 to a different communication network.

The electronic device 800 also includes a transmission power controller 814 and a transmitter 812. In some embodiments, the transmission power controller 814 and the transmitter 812 may be included as part of a communication unit 808. In some embodiments, the communication unit 808 may also have a dedicated processor (e.g., such as a communication unit comprising a system on a chip, or board with multiple chips, or multiple boards, in which the communication may have one or more dedicated processor or processing unit(s), in addition to the processor 802).

As described above in FIGS. 1-7, the transmission power controller 814 may implement functionality related to adjusting transmission power settings. For example, the transmission power controller 814 may be suitable to control the power levels utilized by the transmitter 812 for communicating signals to one or more receiving devices. Changes to the transmission power settings utilized for the signals may be initiated to prevent interference with a broadcast radio transmission that is detected. The broadcast radio transmission may be detected by a transmitting device, receiving device, or other detecting device in communication with the transmitting device or the receiving device. In some embodiments, only a carrier frequency that interferes with the broadcast radio transmission is changed in a signal. For example, a number of other carrier frequencies in the signal may remain unchanged. In another example, adjacent carrier frequencies may also be adjusted. The transmission power level utilized for transmitting the carrier frequency may be increased again once a time period has expired, which may include a delay following the last broadcast radio transmission. Adjustments to the transmission power settings including at least power level and modulation may be made utilizing measurements or characteristics, such as SNR, errors, or so forth that may be associated with the signal.

Any one of these functionalities may be partially (or entirely) implemented in hardware and/or on the processor 802. For example, the functionality may be implemented with an application specific integrated circuit, in logic implemented in the processor 802, in a co-processor on a peripheral device or card, etc. Further, realizations may include fewer or additional components not illustrated in FIG. 8 (e.g., video cards, audio cards, additional network interfaces, peripheral devices, etc.). The processor 802, the memory 806, and the network interfaces 804 are coupled to the bus 810. Although illustrated as being coupled to the bus 810, the memory 806 may be coupled to the processor 802.

While the embodiments are described with reference to various implementations and exploitations, in addition these embodiments are illustrative and that the scope of the present disclosure is not limited to them. In general, techniques for lowering transmission power responsive to broadcast radio transmission as described herein may be implemented with facilities consistent with any hardware system or hardware systems. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the present disclosure. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the present disclosure.

What is claimed is:

1. A method for communicating via a powerline communication (PLC) medium, the method comprising:
transmitting, via the PLC medium, a signal having at least a first carrier frequency associated with a transmission power setting;
detecting a broadcast radio transmission;
lowering the transmission power setting associated with the first carrier frequency from a first power level to a second power level that is lower than the first power level, in response to detecting the broadcast radio transmission; and
transmitting, via the PLC medium, the signal having at least the first carrier frequency at the second power level during a time period associated with the broadcast radio transmission.

2. The method of claim 1, further comprising:
obtaining signal-to-noise ratio (SNR) measurements of the signal measured during the time period.

3. The method of claim 2, further comprising:
increasing the transmission power setting after the time period associated with the broadcast radio transmission, wherein the increasing is in response to the SNR measurements obtained during the time period.

4. The method of claim 1, further comprising:
increasing the transmission power setting associated with the first carrier frequency based at least on expiration of the time period associated with the broadcast radio transmission.

5. The method of claim 1, wherein data is communicated via the signal having at least the first carrier frequency at the second power level during the time period associated with the broadcast radio transmission, wherein the broadcast radio transmission and the first carrier frequency are associated with a frequency range.

6. The method of claim 1, further comprising:
determining the second power level based at least in part on a maximum power level.

7. The method of claim 1, wherein the first power level is associated with a default power level for the signal having the at least the first carrier frequency.

8. The method of claim 1, wherein the signal includes a plurality of carrier frequencies including the first carrier frequency.

9. The method of claim 8, wherein the plurality of carrier frequencies includes a second carrier frequency, and wherein the transmission power setting is lowered for the first carrier frequency differently from the second carrier frequency in response to detecting the broadcast radio transmission.

10. The method of claim 1, wherein the detecting comprises receiving, from another device, a message indicating that the broadcast radio transmission was detected.

11. The method of claim 1, further comprising:
communicating, to a receiving device, an indicator indicating that the transmission power setting for the first carrier frequency has been lowered to the second power level.

12. The method of claim 1, further comprising:
lowering the transmission power setting associated with a second carrier frequency in response to detecting the broadcast radio transmission.

13. An apparatus for communicating via a powerline communication (PLC) network, the apparatus comprising:
a transmitter to transmit, via a PLC medium, a signal having at least a first carrier frequency associated with a transmission power setting;
a transmission power controller configured to:
detect a broadcast radio transmission;
lower the transmission power setting associated with the first carrier frequency from a first power level to a second power level that is lower than the first power level in response to detection of the broadcast radio transmission; and
transmit, via the PLC medium, the signal having at least the first carrier frequency at the second power level.

14. The apparatus of claim 13, wherein the transmission power controller is further configured to obtain signal-to-noise ratio (SNR) measurements of the signal measured during transmission at the second power level.

15. The apparatus of claim 13, wherein the transmission power controller increases the transmission power setting after a time period associated with the broadcast radio transmission, wherein the increasing is in response to SNR measurements obtained during the time period.

16. The apparatus of claim 13, wherein the transmission power controller increases the transmission power setting associated with the first carrier frequency based at least on expiration of a time period associated with the broadcast radio transmission.

17. The apparatus of claim 13, wherein data is communicated via the signal having at least the first carrier frequency at the second power level during a time period associated with the broadcast radio transmission, wherein the broadcast radio transmission and the first carrier frequency are associated with a frequency range.

18. The apparatus of claim 13, further comprising:
a receiver to receive a message indicating that the broadcast radio transmission was detected by another device, wherein the transmission power controller is further configured to detect the broadcast radio transmission based at least in part on the message.

19. A non-transitory machine-readable medium having instructions stored therein, which when executed by a processor causes the processor to perform operations that comprise:
transmitting, via a powerline communication (PLC) medium, a signal having at least a first carrier frequency associated with a transmission power setting;
detecting a broadcast radio transmission;
lowering the transmission power setting associated with the first carrier frequency from a first power level to a second power level that is lower than the first power level in response to detecting the broadcast radio transmission; and
transmitting, via the PLC medium, the signal having at least the first carrier frequency at the second power level during a time period associated with the broadcast radio transmission.

20. The non-transitory machine-readable medium of claim 19, wherein the operations further comprise:
obtaining signal-to-noise ratio (SNR) measurements of the signal measured during the time period.

21. The non-transitory machine-readable medium of claim 20, wherein the operations further comprise:
increasing the transmission power setting from the second power level to the first power level, wherein the increasing is in response to the SNR measurements measured during the time period.

22. The non-transitory machine-readable medium of claim 19, wherein the operations further comprise:
increasing the transmission power setting associated with the first carrier frequency based at least in part on expiration of the time period associated with the broadcast radio transmission.

23. The non-transitory machine-readable medium of claim 19, wherein the operations further comprise:
determining the second power level based at least in part on a maximum power level.

24. The non-transitory machine-readable medium of claim 19, wherein the operations further comprise:
communicating, to a receiving device, an indicator that indicates that the transmission power setting for the first carrier frequency has been lowered to the second power level.

25. The non-transitory machine-readable medium of claim 19, wherein the operations further comprise:
lowering the transmission power setting associated with a second carrier frequency in response to detecting the broadcast radio transmission.

26. A method for communicating via a powerline communication (PLC) medium, the method comprising:
determining channel conditions associated with a plurality of carrier frequencies on the PLC medium;
detecting a broadcast radio transmission associated with at least one of the plurality of carrier frequencies;
lowering transmission power levels of a subset of the plurality of carrier frequencies based at least in part on the channel conditions and in response to detecting the broadcast radio transmission; and
transmitting, via the PLC medium, a signal having the plurality of carrier frequencies utilizing the lowered transmission power levels during a time period associated with the broadcast radio transmission.

27. The method of claim 26, wherein the transmission power levels vary for the plurality of carrier frequencies.

28. The method of claim 26, wherein lowering the transmission power levels comprises lowering the transmission power levels by predetermined values for each of the subset of the plurality of carrier frequencies.

29. The method of claim 26, wherein the channel conditions include signal-to-noise ratio (SNR) measurements.

30. The method of claim 29, further comprising increasing the transmission power levels for the subset of the plurality of carrier frequencies following the time period associated with the broadcast radio transmission, wherein the increasing is in response to the SNR measurements measured during the time period.
